(19) United States
(12) Patent Application Publication
(10) Pub. No.: US 2026/0144254 A1
(43) Pub. Date: May 28, 2026

(54) SUSTAINED-RELEASE PHEROMONE FORMULATION AND METHOD FOR CONTROLLING A PEST USING THE SAME

(71) Applicant: SHIN-ETSU CHEMICAL CO., LTD., Tokyo (JP)

(72) Inventors: Kazuma OZAKI, Joetsu-shi (JP); Tatsuya HOJO, Joetsu-shi (JP); Yuki MIYAKE, Joetsu-shi (JP)

(73) Assignee: SHIN-ETSU CHEMICAL CO., LTD., Tokyo (JP)

(21) Appl. No.: 19/379,454

(22) Filed: Nov. 4, 2025

(30) Foreign Application Priority Data
Nov. 28, 2024 (JP) 2024-206964

(51) Int. Cl. A01N 35/02; A01P 19/00

(52) U.S. Cl. CPC A01N 35/02; A01P 19/00

(57) ABSTRACT

The present invention provides a sustained-release pheromone formulation comprising at least: a mixture containing at least a pheromone substance, such as a sex pheromone substance, which is an aldehyde compound having a total of 14 to 18 carbon atoms with three or more unsaturated carbon-carbon bonds, and an aliphatic acetate having a total of 2 to 4 more carbon atoms than the total number of carbon atoms of the sex pheromone; and a container in which the mixture is included. The present invention further provides a pest control method comprising at least a step of installing the aforesaid sustained-release pheromone formulation in a field to release the pheromone substance, such as the sex pheromone substance, from inside the sustained-release pheromone formulation.

### TECHNICAL FIELD

One aspect of the present invention relates to a sustained-release pheromone formulation. Another aspect of the present invention also relates to a method for controlling a pest using the sustained-release pheromone formulation.

### BACKGROUND ART

Pheromone substances include sex pheromones, alarm pheromones, trail pheromones, and aggregation pheromones or the like. Currently, there is a strong need to establish “mass trapping”, or “attract and kill”, and/or “mating disruption” as pest control technologies that use sex pheromone substances among the pheromone substances as an alternative to pesticide spraying. To reduce the mating rate of male adults in the field and limit the next generation, the mass trapping uses the sex pheromone substance of the target pest as an attractant in traps to exterminate large amounts of male adults in the field; the attract and kill uses a formulation that comprises an insecticide with a sex pheromone used for a target pest to exterminate male adults in the field; and the mating disruption releases large amounts of the sex pheromone substance into the atmosphere to disrupt communication between males and females. It is therefore extremely important to develop a sustained-release formulation for these processes that can stably release the sex pheromone substance throughout the pest outbreak period.

The sex pheromone substances of pests such as Stenoma catenifer, Ectomyelois ceratoniae, Phyllocnistis citrella, and Agriphila aeneociliella are aldehyde compounds having 14 to 18 carbon atoms with three unsaturated carbon-carbon bonds. A known pest control method of the Stenoma catenifer uses a sustained-release formulation containing at least the sex pheromone substances, (Z)-9,13-tetradecadien-11-ynal and (E)-9,13-tetradecadien-11-ynal (Patent Literature 1 below).

Generally, aldehyde compounds are extremely prone to oxidative decomposition, or multimerization, or polymerization. For this reason, in a sustained-release formulation containing an aldehyde compound as sex pheromone substances, a mixture of the aldehyde compound with a stabilizer such as an antioxidant or a polymerization inhibitor is included inside a container. However, although the antioxidant or polymerization inhibitor effectively stabilizes the mixture inside the container, the antioxidant or polymerization inhibitor has no effect on the aldehyde compound that has passed through the container. In particular, a polymerization reaction of the aldehyde compound that has passed through to the outer surface of the container occurs to form a polymer layer, which inhibits the release of the aldehyde compound still inside the container. Therefore, it has been necessary to replace sustained-release formulations multiple times over the pest control period, causing a problem of increased labor.

Technology for releasing an aldehyde compound over a long period is reported in which, for example, a sustained-release formulation is a mixture of an aliphatic derivative and a sex pheromone substance which is an aldehyde having 10 to 18 carbon atoms (Patent Literature 2 below). Specifically, the aliphatic derivative is selected from (i) an aliphatic acetate having 2 to 4 fewer carbon atoms than the sex pheromone substance, (ii) an aliphatic alcohol having 2 to 6 fewer carbon atoms than the sex pheromone substance, and (iii) an aliphatic carboxylic acid ester having the same number of carbon atoms as the sex pheromone substance or 1 to 4 fewer carbon atoms than the sex pheromone.

### PRIOR ART

### Patent Literatures

[Patent Literature 1] Japanese Patent Application Laid-Open No. 2023-4541.
[Patent Literature 2] Japanese Patent Application Laid-Open No. 2006-232851.

### OBJECT OF THE INVENTION

When, however, an aldehyde compound having a total of 14 to 18 carbon atoms with three or more unsaturated carbon-carbon bonds was used as the sustained-release formulation of Patent Literature 2, there was room for improvement in the release of the aldehyde compound over the pest control period (for example, about six months). The inventors found by trial and error that when using the aldehyde compound, the release rate of the aliphatic derivative increased relative to that of the aldehyde compound. It is considered that the increase of the release rate inhibited release of the aldehyde compound during the initial release, causing the aldehyde compound concentration inside the container to increase. When the concentrated aldehyde compound began to be released, a polymerization reaction occurred at the outer surface of the container, thereby forming a polymer layer that inhibited release during the control period.

The present invention was made to solve the aforesaid problem, and aims to provide a sustained-release pheromone formulation containing a sex pheromone substance which is an aldehyde compound having a total of 14 to 18 carbon atoms with three or more unsaturated carbon-carbon bonds, in which the release rate of the aldehyde compound is constant over a pest control period.

Furthermore, the present invention provides a method for controlling a pest using the aforesaid sustained-release pheromone formulation.

### SUMMARY OF THE INVENTION

As a result of intensive research to overcome the aforesaid problems of the prior art, the present inventors found that by adding a specific aliphatic derivative different from that of the invention of Patent Literature 2, an aldehyde compound having a total of 14 to 18 carbon atoms with three or more unsaturated carbon-carbon bonds can be released at a constant rate over the pest control period, and thus have completed the present invention.

According to an aspect of the present invention, there is provided a sustained-release pheromone formulation comprising at least:
a mixture containing at least a pheromone substance, such as a sex pheromone substance, which is an aldehyde compound having a total of 14 to 18 carbon atoms with three or more unsaturated carbon-carbon bonds, and an aliphatic acetate having a total of 2 to 4 more carbon atoms than the total number of carbon atoms of the pheromone substance; and
a container in which the mixture is included.

According to another aspect of the present invention, there is provided a sustained-release pheromone formulation comprising at least:
a mixture containing at least a pheromone substance, such as a sex pheromone substance, which is an aldehyde compound having a total of 14 to 18 carbon atoms with three or more unsaturated carbon-carbon bonds, and an aliphatic acetate having a total of 2 to 4 more carbon atoms than the total number of carbon atoms of the pheromone substance;
wherein the sustained-release pheromone formulation is in a container in which the mixture is included.

According to another aspect of the present invention, the pheromone substance may include at least an aldehyde compound having three or more carbon-carbon double bonds and no carbon-carbon triple bond; or an aldehyde compound having two carbon-carbon double bonds and one or more carbon-carbon triple bonds.

According to another aspect of the present invention, the mass ratio of the sex pheromone to the aliphatic acetate may be 95:5 to 30:70.

According to another aspect of the present invention, the container may be at least partially made of a polyolefin polymer and has a shape selected from the group consisting of caps, tubes, capsules, ampules, bags, and bottles.

According to another aspect of the present invention, a pest applied may be a pest comprising the aldehyde compound as a pheromone substance.

According to another aspect of the present invention, the pheromone substances may be sex pheromones, alarm pheromones, trail pheromones, or aggregation pheromones, or a combination thereof, preferably sex pheromones.

In a further another aspect of the present invention, there is provided a method for controlling a pest, comprising at least a step of installing the aforesaid sustained-release pheromone formulation in a field to release the pheromone substance, such as the sex pheromone substance, from inside the sustained-release pheromone formulation into the field.

According to embodiments of the present invention, there is provided a sustained-release pheromone formulation that can release an aldehyde compound that is a sex pheromone substance over a period necessary for pest control (for example, about six months). Labor required to replace the sustained-release pheromone formulation multiple times during the pest control period can be reduced thereby, and it is unnecessary to use excessive amounts of the pheromone substance, such as the sex pheromone substance.

### BRIEF DESCRIPTION OF THE DRAWINGS

FIG. 1 shows the change over time of a percentage of the sex pheromone substance of Stenoma catenifer remaining in a sex pheromone formulation (Examples 1 to 3 and Comparative Examples 1 to 3 below).

FIG. 2 shows the change over time of a percentage of the sex pheromone substance of Phyllocnistis citrella remaining in a sex pheromone formulation (Examples 4 to 5 and Comparative Example 4).

### DETAILED DESCRIPTION OF THE INVENTION

The sustained-release pheromone formulation comprises at least a mixture included in a container, in which the mixture contains at least a pheromone substance, such as, a sex pheromone substance which is an aldehyde compound having a total of 14 to 18 carbon atoms with three or more unsaturated carbon-carbon bonds and a predetermined aliphatic derivative.

The pheromone substance is not particularly limited but may be any pheromone substances called “pheromone” of insect, especially pest, and may be, for example, sex pheromones, alarm pheromones, trail pheromones, or aggregation pheromones, or a combination thereof. The pheromone substance may particularly be a sex pheromone substance. The pheromone substance may be particularly the sex pheromone substance.

The pheromone formulation is not particularly limited but may be any pheromone formulation comprising the pheromone substances called “pheromone” of insect, especially pest, and may comprise, for example, sex pheromones, alarm pheromones, trail pheromones, or aggregation pheromones, or a combination thereof. The pheromone formulation may particularly be a sex pheromone formulation.

Hereinafter, sex pheromone substances among pheromone substances will be described, but it should be noted that the explanation relating to the sex pheromone substances also applies to other pheromone substances, such as alarm pheromones, trail pheromones, and aggregation pheromones.

### (1) Aldehyde Compound (a Pheromone Substance, Such as Sex Pheromone Substance)

First, as a pheromone substance, such as a sex pheromone substance, an aldehyde compound having a total of 14 to 18 carbon atoms with three or more unsaturated carbon-carbon bonds will be explained in detail below.

The number of unsaturated carbon-carbon bonds of the aldehyde compound is 3 or more, preferably 3 to 4, and more preferably 3. The unsaturated carbon-carbon bonds may be carbon-carbon double bonds or carbon-carbon triple bonds. Specific examples include an aldehyde compound having three or more carbon-carbon double bonds and no carbon-carbon triple bonds; or an aldehyde compound having two carbon-carbon double bonds and one or more carbon-carbon triple bonds, or the like.

The total number of carbon atoms of the aldehyde compound includes one carbon atom of the aldehyde group (—CHO). The total number of carbon atoms of the aldehyde compound is 14 to 18, preferably in the range of combination of any lower and any upper limits selected from 14, 15, 16, 17 or 18, for example, in the range of combination of any lower and upper limits selected from 14, 15, or 16 (lower limit) to 17 or 18 (upper limit), and more preferably 14 to 16.

Specific examples of the aldehyde compound include (Z)-9,13-tetradecadien-11-ynal as the sex pheromone of Stenoma catenifer; (Z,E)-9,11,13-tetradecatrienal as the sex pheromone of Stenoma cecropia and Ectomyelois ceratoniae; (E,Z,Z)-2,6,9-pentadecatrienal as the sex pheromone of Elaphidion mucronatum; (E,E,E)-10,12,14-hexadecatrienal as the sex pheromone of Manduca sexta; (E,E,Z)-10,12,14-hexadecatrienal as the sex pheromone of Manduca sexta; (E,E,Z)-4,6,11-hexadecatrienal as the sex pheromone of Philosamia cynthia ricini, Graellsia isabella isabellae, Graellsia isabella paradisea, Graellsia isabellae, and Graellsia isabellae galliaegloria; (Z,Z,E)-7,11,13-hexadecatrienal as the sex pheromone of Phyllocnistis citrella, Phyllocnistis insignis, and Phyllocnistis vitegenella; and (Z,Z,Z)-9,12,15-octadecatrienal as the sex pheromone of Phauda flammans, Agriphila aeneociliella, Eurata patagiata, Bombini ignitus ignitus, Amsacta albistriga, Diacrisia obligua, Estigmene acrea, Hyphantria cunea, Phragmatobia fuliginosa, Spilosoma lubricipeda, Spilosoma luteum, Eupithecia vulgata, and Noctua promiba.

Specific examples of the aforesaid aldehyde compound having a total of 14 to 18 carbon atoms with three or more unsaturated carbon-carbon bonds include (Z,E)-9,11,13-tetradecatrienal, (E,Z,Z)-2,6,9-pentadecatrienal, (E,E,E)-10,12,14-hexadecatrienal, (E,E,Z)-10,12,14-hexadecatrienal, (E,E,Z)-4,6,11-hexadecatrienal, (Z,Z,E)-7,11,13-hexadecatrienal, and (Z,Z,Z)-9,12,15-octadecatrienal or the like.

Specific examples of the aforesaid aldehyde compound having two carbon-carbon double bonds and one or more carbon-carbon triple bonds include (Z)-9,13-tetradecadien-11-ynal or the like.

Although the aldehyde compound may be extracted from the corresponding pest, the use of a synthetic product is economically and industrially preferred.

One type of aldehyde or, if necessary, a combination of two or more types of aldehydes may be used as the sex pheromone. When two or more types are used, it is necessary for the total number of carbon atoms in each aldehyde compound to be within the aforesaid range.

### (2) Aliphatic Acetate

The aliphatic acetate will be explained in detail below.

The aliphatic acetate has a total of 2 to 4 more carbon atoms than the total number of carbon atoms of the pheromone substance, such as the sex pheromone substance. The total number of carbon atoms of an aliphatic acetate includes the two carbon atoms of the acetyl group (CH₃CO—).

Although not wishing to be bound by any theory, if the total number of carbon atoms of the aforesaid aliphatic acetate is more than the aforesaid range, it is thought that the release of the aliphatic acetate decreases relative to the aldehyde compound. Therefore, the aldehyde compound remains at the outer surface of the sustained-release pheromone formulation, a polymerization reaction occurs, and a polymer layer is formed. Furthermore, although not wishing to be bound by any theory, it is thought that the composition ratio of the aliphatic acetate inside the sustained-release pheromone formulation increases, which dilutes the aldehyde compound and reduces the release of the aldehyde compound. These factors result in a nonuniform release.

On the other hand, although not wishing to be bound by any theory, if the total number of carbon atoms of the aforesaid aliphatic acetate is less than the aforesaid range, it is thought that the release of the aliphatic acetate increases relative to the aldehyde compound. Therefore, it is thought that the release of the aldehyde compound is inhibited in the initial release, causing the aldehyde compound to concentrate inside the container. When the concentrated aldehyde compound begins to be released, a polymerization reaction occurs at the outer surface of the container to form a polymer layer. These factors result in a nonuniform release.

The total number of carbon atoms of the aliphatic acetate is 2 to 4 more than the total number of carbon atoms of the pheromone substance, such as the sex pheromone substance, selected according to the pest to be controlled.

The aliphatic acetate having a total of 2 to 4 more carbon atoms than the total number of carbon atoms of the sex pheromone substance is an aliphatic acetate having preferably an alkyl group or alkenyl group having 14 to 20 carbon atoms, more preferably an alkyl group or alkenyl group having carbon atoms in the range of combination of any lower and any upper limits selected from 14, 15, 16, 17, 18, 19 or 20, for example, an alkyl group or alkenyl group having carbon atoms in the range of combination of any lower and upper limits selected from 14, 15, or 16 (lower limit) to 17, 18, 19 or 20 (upper limit), and more particularly preferably an alkyl group or alkenyl group having 14 to 18 carbon atoms.

Examples of the alkyl group having 14 to 20 carbon atoms include linear alkyl groups such as a tetradecyl group, a pentadecyl group, a hexadecyl group, a heptadecyl group, an octadecyl group, a nonadecyl group, and an icosyl group; branched alkyl groups such as a methyltridecyl group, a methyltetradecyl group, a methylpentadecyl group, a methylhexadecyl group, a methylheptadecyl group, a methyloctadecyl group, a methylnonadecyl group, an ethyldodecyl group, an ethyltridecyl group, an ethyltetradecyl group, an ethylpentadecyl group, an ethylhexadecyl group, an ethylheptadecyl group, an ethyloctadecyl group, a dimethyldodecyl group, a dimethyltridecyl group, a dimethyltetradecyl group, a dimethylpentadecyl group, a dimethylhexadecyl group, a dimethylheptadecyl group, a dimethyloctadecyl group, a propylundecyl group, a propyldodecyl group, a propyltridecyl group, a propyltetradecyl group, a propylpentadecyl group, a propylhexadecyl group, a propylheptadecyl group, an ethylmethylundecyl group, an ethylmethyldodecyl group, an ethylmethyltridecyl group, an ethylmethyltetradecyl group, an ethylmethylpentadecyl group, an ethylmethylhexadecyl group, an ethylmethylheptadecyl group, a trimethylundecyl group, a trimethyldodecyl group, a trimethyltridecyl group, a trimethyltetradecyl group, a trimethylpentadecyl group, a trimethylhexadecyl group, a trimethylheptadecyl group, a diethyldecyl group, a diethylundecyl group, a diethyldodecyl group, a diethyltridecyl group, a diethyltetradecyl group, a diethylpentadecyl group, and a diethylhexadecyl group; and cyclic alkyl groups such as a cyclotetradecyl group, a cyclopentadecyl group, a cyclohexadecyl group, a cycloheptadecyl group, a cyclooctadecyl group, a cyclononadecyl group, and a cycloicosyl group.

Examples of the alkenyl group having 14 to 20 carbon atoms include linear alkenyl groups such as a tetradecenyl group, a pentadecenyl group, a hexadecenyl group, a heptadecenyl group, an octadecenyl group, a nonadecenyl group, an icocenyl group, a tetradecadienyl group, a pentadecadienyl group, a hexadecadienyl group, a heptadecadienyl group, an octadecadienyl group, a nonadecadienyl group, and an icosadienyl group; branched alkenyl groups such as a methyltridecenyl group, a methyltetradecenyl group, a methylpentadecenyl group, a methylhexadecenyl group, a methylheptadecenyl group, a methyloctadecenyl group, a methylnonadecenyl group, an ethyldodecenyl group, an ethyltridecenyl group, an ethyltetradecenyl group, an ethylpentadecenyl group, an ethylhexadecenyl group, an ethylheptadecenyl group, an ethyloctadecenyl group, a dimethyldodecenyl group, a dimethyltridecenyl group, a dimethyltetradecenyl group, a dimethylpentadecenyl group, a dimethylhexadecenyl group, a dimethylheptadecenyl group, a dimethyloctadecenyl group, a propylundecenyl group, a propyldodecenyl group, a propyltridecenyl group, a propyltetradecenyl group, a propylpentadecenyl group, a propylhexadecenyl group, a propylheptadecenyl group, an ethylmethylundecenyl group, an ethylmethyldodecenyl group, an ethylmethyltridecenyl group, an ethylmethyltetradecenyl group, an ethylmethylpentadecenyl group, an ethylmethylhexadecenyl group, an ethylmethylheptadecenyl group, a trimethylundecenyl group, a trimethyldodecenyl group, a trimethyltridecenyl group, a trimethyltetradecenyl group, a trimethylpentadecenyl group, a trimethylhexadecenyl group, a trimethylheptadecenyl group, a diethyldecenyl group, a diethylundecenyl group, a diethyldodecenyl group, a diethyltridecenyl group, a diethyltetradecenyl group, a diethylpentadecenyl group, a diethylhexadecenyl group, a methyltridecadienyl group, a methyltetradecadienyl group, a methylpentadecadienyl group, a methylhexadecadienyl group, a methylheptadecadienyl group, a methyloctadecadienyl group, a methylnonadecadienyl group, an ethyldodecadienyl group, an ethyltridecadienyl group, an ethyltetradecadienyl group, an ethylpentadecadienyl group, an ethylhexadecadienyl group, an ethylheptadecadienyl group, an ethyloctadecadienyl group, a dimethyldodecadienyl group, a dimethyltridecadienyl group, a dimethyltetradecadienyl group, a dimethylpentadecadienyl group, a dimethylhexadecadienyl group, a dimethylheptadecadienyl group, a dimethyloctadecadienyl group, a propylundecadienyl group, a propyldodecadienyl group, a propyltridecadienyl group, a propyltetradecadienyl group, a propylpentadecadienyl group, a a propylhexadecadienyl group, propylheptadecadienyl group, an ethylmethylundecadienyl group, an ethylmethyldodecadienyl group, an ethylmethyltridecadienyl group, an ethylmethyltetradecadienyl group, an ethylmethylpentadecadienyl group, an ethylmethylhexadecadienyl group, an ethylmethylheptadecadienyl group, a trimethylundecadienyl group, a trimethyldodecadienyl group, a trimethyltridecadienyl group, a trimethyltetradecadienyl group, a trimethylpentadecadienyl group, a trimethylhexadecadienyl group, a trimethylheptadecadienyl group, a diethyldecadinyl group, a diethylundecadinyl group, a diethyldodecadienyl group, a diethyltridecadienyl group, a diethyltetradecadienyl group, a diethylpentadecadienyl group, and a diethylhexadecadienyl group; and cyclic alkenyl groups such as a cyclotetradecenyl group, a cyclopentadecenyl group, a cyclohexadecenyl group, a cycloheptadecenyl group, a cyclooctadecenyl group, a cyclononadecenyl group, a cycloicosenyl group, a cyclotetradecadienyl group, a cyclopentadecadienyl group, a cyclohexadecadienyl group, a cycloheptadecadienyl group, a cyclooctadecadienyl group, a cyclononadecadienyl group, and a cycloicosadienyl group.

Among the aforesaid groups, linear alkyl groups and linear alkenyl groups are preferred. Specific examples of the aforesaid aliphatic acetate having such substituents include tetradecyl acetate, pentadecyl acetate, hexadecyl acetate, heptadecyl acetate, octadecyl acetate, nonadecyl acetate, icosyl acetate, tetradecenyl acetate, pentadecenyl acetate, hexadecenyl acetate, heptadecenyl acetate, octadecenyl acetate, nonadecenyl acetate, and icosenyl acetate or the like.

The aliphatic acetate may contain one type of aliphatic acetate or, if necessary, a combination of two or more types. When two or more types are used, the carbon numbers of the respective aliphatic acetates may be the same or different, and further, it is necessary for the total number of carbon atoms of each type of aliphatic acetate to be within the aforesaid range.

### (3) Sustained-Release Pheromone Formulation (or Sustained-Release Pheromone Preparation)

The sustained-release pheromone formulation contains at least a mixture and a container in which the mixture is included, in which the mixture contains at least a pheromone substance, such as a sex pheromone substance which is an aldehyde compound having a total of 14 to 18 carbon atoms with three or more unsaturated carbon-carbon bonds, and an aliphatic acetate having a total of 2 to 4 more carbon atoms than the total number of carbon atoms of the pheromone substance, such as sex pheromone substance.

The mass ratio of the pheromone substance, such as the sex pheromone substance, to the aliphatic acetate is preferably 95:5 to 30:70, more preferably 90:10 to 40:60, even more preferably 80:20 to 45:55, and even more preferably 70:30 to 50:50. By using said preferred mass ratio, said more preferred mass ratio, and said even more preferred mass ratio, a preferred release control and/or economy, a more preferred release control and economy, and an even more preferred release control and economy may be ensured.

The amount of the pheromone substance, such as the sex pheromone substance, in the sustained-release pheromone formulation depends on the number of sustained-release pheromone formulation installed, the period of use, and/or the field environment (for example, the temperature and/or wind velocity), or the like. For the length of 0.2 m of the sustained-release pheromone formulation, it is preferable that the amount of the sustained-release pheromone formulation is, for example, 0.015 to 0.76 g.

The sustained-release pheromone formulation may contain, with the mixture, additives such as an antioxidant and/or a UV absorber, if necessary.

Examples of the antioxidant include 2,6-di-tert-butyl-4-methylphenol (BHT), 4,4′-butylidenebis(6-tert-butyl-m-cresol) (BBMTBP), 2,2′-methylenebis(4-methyl-6-tert-butylphenol) (MBMTBP), 2,2′-methylenebis(4-ethyl-6-tert-butylphenol), butylhydroxytoluene, butylhydroxyanisole, hydroquinone, and vitamin E.

Examples of the UV absorber include 2-hydroxy-4-octyloxybenzophenone, 2-(2′-hydroxy-3′-tert-butyl-5′-methylphenyl)-5-chlorobenzotriazole (HBMCBT), 2-ethylhexyl salicylate, 3,3,5-trimethylcyclohexyl salicylate, 2-ethylhexyl 4-methoxy-trans-cinnamate, and diethylamino hydroxybenzoyl hexyl benzoate.

For example, the amount of the additive, per total 100 parts by mass of the mixture, is preferably 0.5 to 50 parts by mass of the antioxidant and 0.5 to 50 parts by mass of the UV absorber.

The container in which the mixture is included is not particularly limited as long as the container can releasably store the pheromone substance, such as the sex pheromone substance, but it is preferred that the container is at least partially made of or at least partially includes a polyolefin polymer. When container in which the mixture is included contains at least a polyolefin-based polymer, and the container is a bag, the shape of the container may be, for example, such that the surface of the container is made of a polyolefin-based polymer and the opposite surface of the container is made of another material.

In one embodiment, the container is a can having a sprayable valve to release the sex pheromone from inside the sustained-release pheromone formulation. A sustained release pheromone formulation comprising a container may be produced by a well-known method. It may be produced, for example, by the method comprising steps of: injecting the bioactive composition or the like into a polymer tube, and sealing both ends of the tube; or by the method comprising steps of: filling a can with the bioactive composition or the like, and attaching a sprayable valve to the can.

Examples of the polyolefin polymer include polyethylene, polypropylene, and ethylene-vinyl acetate copolymers. The amount of the vinyl acetate units, which are repeating units derived from vinyl acetate, in the ethylene-vinyl acetate copolymers is preferably 0.5 to 10% by weight, more preferably 0.5 to 6% by weight, and even more preferably 0.5 to 3% by weight. By using said preferred amount, said more preferred amount, and said even more preferred amount, a preferred release performance and processibility, a more preferred release performance and processibility, and an even more preferred release performance and processibility may be ensured. The weight-average molecular weight (Mw) of the ethylene-vinyl acetate copolymers, while not particularly limited, is preferably 50,000 to 500,000. By using said preferred weight-average molecular weight, a preferred release performance and processibility may be ensured. The weight-average molecular weight (Mw) of the ethylene-vinyl acetate copolymers may be determined by polystyrene-equivalent gel permeation chromatography (GPC).

The shape of the container is not particularly limited as long as the shape can stably hold the pheromone substance, such as the sex pheromone substance, and can store the pheromone substance, such as the sex pheromone substance, so as to be releasable in ambient air. Examples of the container shape include caps, tubes, capsules, ampules, bags, and bottles or the like.

At least a part of the container or the entire container may be permeable to the pheromone substance, such as the sex pheromone substance.

The sustained-release pheromone formulation preferably includes a tubular container, with an inner diameter of preferably 0.5 to 2.5 mm, with a surface area of preferably 600 to 130,000 mm², with a wall thickness of preferably 0.3 to 0.8 mm, and with a length of preferably 0.01 to 100 m, more preferably 0.02 to 20 m, and even more preferably 0.2 to 10 m. By using said tubular container, a preferred uniformity of the release of the pheromone substance, such as the sex pheromone substance, may be ensured.

Additives to the container itself may include, for example, a colorant, an antioxidant, a UV absorber, an antiblocking agent, and/or a lubricant, if necessary.

The colorant may be added in an amount of preferably 3% or less, and more preferably 1% or less, per mass of the container. By using said preferred amount and said more preferred amount, a preferred prevention of degradation of the pheromone substance, such as the sex pheromone substance, due to ultraviolet light and a more preferred prevention of degradation of the sex pheromone due to ultraviolet light may be ensured. Examples of the colorant include an inorganic colorant and an organic colorant. Examples of the inorganic colorant include iron oxide, chromium oxide, titanium oxide, and carbon black. Examples of the organic colorant include a polycyclic pigment and an azo pigment.

The antioxidant and/or the UV absorber may be added in an amount of preferably 1% or less in total, per mass of the container. By using said preferred amount, a preferred prevention of degradation of the polymer when used may be ensured. Examples of the antioxidant include a phenol-based antioxidant, a sulfur-based antioxidant, and a phosphorus-based antioxidant. Examples of the UV absorber include benzotriazoles and benzophenones.

The antiblocking agent and/or the lubricant may be added in an amount of preferably 1% or less in total, per mass of the container. By using said preferred amount, a preferred improvement of processibility of the container may be ensured. Examples of the antiblocking agent include a metal salt of a higher fatty acid and an inorganic powder. Examples of the lubricant include hydrocarbons, alcohols, higher fatty acids, esters, polyhydric alcohol partial esters, higher fatty acid metal salts, natural waxes, fatty acid amides, and polymers.

The sustained-release pheromone formulation is obtained by, for example, loading and enclosing a mixture in a container formed by blow molding, extrusion, or the like. In some cases, the mixture may be loaded and included using the same path that allows air to be pushed out simultaneously with forming.

### (4) Pest Control Method

Next, a method for controlling a pest, comprising at least a step of installing the aforesaid sustained-release pheromone formulation in a field to release the pheromone substance, such as the sex pheromone substance, from inside the sustained-release pheromone formulation in the field will be explained in detail below.

Examples of the pest control method include mass trapping or attract-and-kill, push-pull, attract-and-infect, and mating disruption. The sustained-release pheromone formulation is especially applicable to such pest control methods for pests present in fields. Specific pests are as mentioned above.

The installation of the sustained release pheromone formulation in a field is not particularly limited. For example, the installation density of the sustained release pheromone formulation is preferably 0.10 to 2,000 installation locations/ha, and more preferably 0.25 to 1,000 installation locations/ha, with the proviso that the sustained release pheromone formulation is uniformly installed in the field to be controlled. The amount released from one installation location depends on the field environment, and/or meteorological conditions, or the like. It is not particularly limited as long as the pheromone substance, such as the sex pheromone substance, may be such an amount to allow uniform float in the field. The amount released is preferably 0.0001 to 20 g/day.

Pests to which the sustained-release pheromone formulation is applicable are pests having the aforesaid aldehyde compound as the sex pheromone substance, and are, for example, pests mentioned in relation to the aldehyde compound previous described herein.

The pests are not limited to those belonging to the genera listed below, but may be any pests that contain the aforesaid aldehyde compound as the pheromone substance, such as the sex pheromone substance, and examples thereof include insects of the genera Stenomas, Ectomyelois, Elaphidion, Manduca, Philosamia, Graellsia, Phyllocnistis, Phauda, Agriphila, Eurata, Bombini, Amsacta, Diacrisia, Estigmene, Hyphantria, Phragmatobia, Spilosoma, Eupithecia, and Noctua. The aforesaid biological classification is based on the morphology of the insects and has no relation to the type and composition of the pheromones including the sex pheromone.

The pests include, but are not limited to, any pest that contains the aforesais aldehyde compound as the pheromone substance, such as the sex pheromone substance, such as Stenomatous catenifer, Stenomatous cecropia, Ectomyelitis ceratoniae, Elaphidion mucronatum. Manduca sexta, Philosamia cynthia ricini, Graellsia isabella isabellae, Graellsia isabella paradisea, Graellsia isabellae, Graellsia isabellae galliaegloria, Phyllocnistis citrella, Phyllocnistis insignis, Phyllocnistis vitegenella, Phauda flammans, Agriphila aeneociliella, Eurata patagiata, Bombini ignitus ignitus, Amsacta albistriga, Diacrisia obligua, Estigmene acrea, Hyphantria cunea, Phragmatobia fuliginosa, Spilosoma lubricipeda, Spilosoma luteum, Eupithecia vulgata and Noctua pronuba. The pests include, in particular, Stenoma catenifer, Manduca sexta, Phyllocnistis citrella, Phyllocnistis insignis, and Phyllocnistis vitegenella, or the like, and more in particular, Stenoma catenifer, Manduca sexta, and Phyllocnistis citrella.

### EXAMPLES

The present invention will be concretely described with reference to the following Examples. It should be noted that the present invention is not limited to or by the following Examples.

Hereinafter, the internal standard method/gas chromatogram analysis was performed under the following GC conditions.

GC conditions: GC: Agilent capillary gas chromatograph 8890, column: Rtx-2330, 0.25 mm×0.25 μm φ×60 m, carrier gas: He (1.0 mL/min), detector: FID, column temperature: 180° C., elevated in a rate of 10° C./min, and up to 230° C.

### Example 1

An active agent for the pheromone formulation was prepared by forming a mixture of 50 parts by mass of the sex pheromone of Stenoma catenifer, (Z)-9,13-tetradecadien-11-ynal (Y11Z9, 13-14: Ald), mixed with 50 parts by mass of n-hexadecyl acetate (n-16: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. About 100 mg of the active agent for the pheromone formulation was loaded into a tubular container made of polyethylene with an inner diameter of 0.84 mm, an outer diameter of 1.54 mm, and a length of 200 mm. The two ends of the container were then heat-sealed to form a pheromone formulation.

The mixtures inside thirty-five sustained-release pheromone formulation thus prepared were released by leaving under conditions of 30° C. and a wind velocity of 1.0 m/sec.

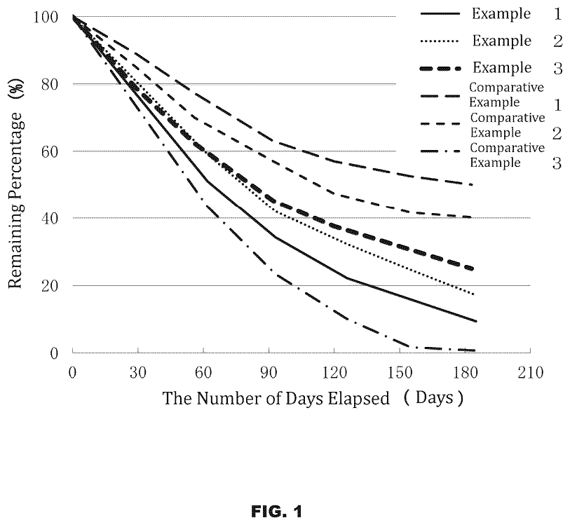

Five sustained-release pheromone formulation were recovered after 29, 56, 92, 120, 155, and 183 days, and the average value of the remaining percentage of (Z)-9,13-tetradecadien-11-ynal measured by an internal standard method of gas chromatography was calculated for each set of five. The results are shown in FIG. 1.

### Example 2

An active agent for the pheromone formulation was prepared by forming a mixture of 50 parts by mass of the sex pheromone of Stenoma catenifer, (Z)-9,13-tetradecadien-11-ynal (Y11Z9, 13-14: Ald), mixed with 50 parts by mass of n-tetradecyl acetate (n-14: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared similarly to Example 1 with the proviso that the active agent for the pheromone formulation was changed, and then a release test was carried out. The results are shown in FIG. 1.

### Example 3

An active agent for the pheromone formulation was prepared by forming a mixture of 70 parts by mass of the sex pheromone of Stenoma catenifer, (Z)-9,13-tetradecadien-11-ynal (Y11Z9, 13-14: Ald), mixed with 30 parts by mass of n-tetradecyl acetate (n-14: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared similarly to Example 1 with the proviso that the active agent for the pheromone formulation was changed, and then a release test was carried out. The results are shown in FIG. 1.

### Comparative Example 1

An active agent for the pheromone formulation was prepared by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the sex pheromone of Stenoma catenifer, (Z)-9,13-tetradecadien-11-ynal (Y11Z9, 13-14: Ald), followed by mixing, but without adding an aliphatic derivative. A pheromone formulation was prepared similarly to Example 1 with the proviso that the active agent for the pheromone formulation was changed, and then a release test was carried out. The results are shown in FIG. 1.

### Comparative Example 2

An active agent for the pheromone formulation was prepared by forming a mixture of 70 parts by mass of the sex pheromone of Stenoma catenifer, (Z)-9,13-tetradecadien-11-ynal (Y11Z9, 13-14: Ald), mixed with 30 parts by mass of n-dodecyl acetate (n-12: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared similarly to Example 1 with the proviso that the active agent for the pheromone formulation was changed, and then a release test was carried out. The results are shown in FIG. 1.

### Comparative Example 3

An active agent for the pheromone formulation was prepared by forming a mixture of 50 parts by mass of the sex pheromone of Stenoma catenifer, (Z)-9,13-tetradecadien-11-ynal (Y11Z9, 13-14: Ald), mixed with 50 parts by mass of n-heptadecyl acetate (n-17: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared similarly to Example 1 with the proviso that the active agent for the pheromone formulation was changed, and then a release test was carried out. The results are shown in FIG. 1.

It can be seen from FIG. 1 that the remaining percentages of the formulations of Examples 1 to 3 decreased day by day over a period of more than 180 days, indicating that the aldehyde compound was continuously released for at least 180 days (about six months).

Meanwhile, it can be seen that the remaining percentage of the aldehyde compound of the formulation of Comparative Example 1 decreased very gradually, and there was little change of the remaining percentage especially from the vicinity of 120 days, indicating that the aldehyde compound was insufficiently released after 120 days. The remaining percentage of the formulation of Comparative Example 2 decreased more than Comparative Example 1, but the change of the remaining percentage decreased from the vicinity of 120 days, and there was almost no change of the remaining percentage after 150 days, indicating that the release of the formulation of Comparative Example 2 was insufficient compared to the formulations of Examples 1 to 3. It can be seen that the remaining percentage of Comparative Example 3 decreased rapidly, but became substantially 0% at the vicinity of 150 days, indicating that the release did not last for the required control period (about six months).

TABLE 1

| | Sex pheromone substance | | | Aliphatic acetate | | |
|---|---|---|---|---|---|---|
| | Aldehyde | Mass | Total | | Mass | Total |
| | compounds | ratio | carbon atoms | Compounds | ratio | carbon atoms |
| Example 1 | Y11Z9,13-14:Ald | 50 | 14 | n-16:Ac | 50 | 18 |
| Example 2 | Y11Z9,13-14:Ald | 50 | 14 | n-14:Ac | 50 | 16 |
| Example 3 | Y11Z9,13-14:Ald | 70 | 14 | n-14:Ac | 30 | 16 |
| Comparative | Y11Z9,13-14:Ald | 100 | 14 | None | | |
| Example 1 | | | | | | |
| Comparative | Y11Z9,13-14:Ald | 70 | 14 | n-12:Ac | 30 | 14 |
| Example 2 | | | | | | |
| Comparative | Y11Z9,13-14:Ald | 50 | 14 | n-17:Ac | 50 | 19 |
| Example 3 | | | | | | |

### Example 4

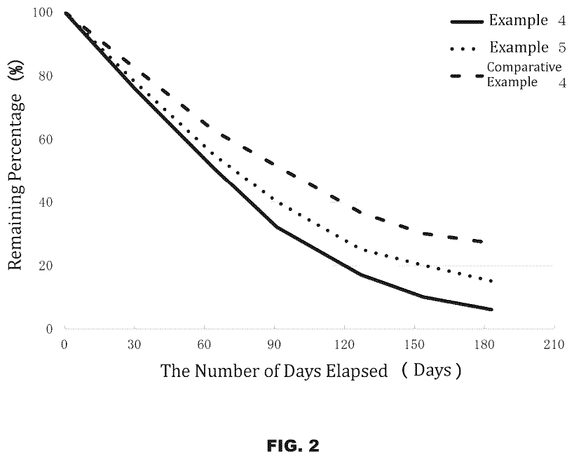

An active agent for the pheromone formulation was prepared by forming a mixture of 70 parts by mass of the sex pheromone of Phyllocnistis citrella, (Z,Z,E)-7,11,13-hexadecatrienal (Z7Z11E13-16: Ald), mixed with 30 parts by mass of n-octadecyl acetate (n-18: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared in the same manner as in Example 1, except that the raw material for the pheromone formulation was changed, and then a release test was carried out. The results are shown in FIG. 2.

### Example 5

An active agent for the pheromone formulation was prepared by forming a mixture of 70 parts by mass of the sex pheromone of Phyllocnistis citrella, (Z,Z,E)-7,11,13-hexadecatrienal (Z7Z11E13-16: Ald), mixed with 30 parts by mass of n-hexadecyl acetate (n-16: Ac), followed by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the mixture, followed by mixing. A pheromone formulation was prepared in the same manner as in Example 1, except that the raw material for the pheromone formulation was changed, and then a release test was carried out. The results are shown in FIG. 2.

### Comparative Example 4

An active agent for the pheromone formulation was prepared by adding 2 parts by mass of BHT (2,6-di-tert-butyl-4-methylphenol) and 2 parts by mass of HBMCBT (2-(2′-hydroxy-3′-tert-butyl-5′methylphenyl)-5-chlorobenzotriazole) as stabilizers, per 100 parts by mass of the sex pheromone of Phyllocnistis citrella, (Z,Z,E)-7,11,13-hexadecatrienal (Z7Z11E13-16: Ald), followed by mixing, but without adding an aliphatic derivative. A pheromone formulation was prepared similarly to Example 1 with the proviso that the active agent for the pheromone formulation was changed, and then a release test was carried out. The results are shown in FIG. 2.

It can be seen from FIG. 2 that the remaining percentages of the formulations of Examples 4 and 5 decreased day by day over a period of more than 180 days, indicating that the aldehyde compound was continuously released for at least 180 days (about six months).

Meanwhile, it can be seen that the remaining percentage of the aldehyde compound of the formulation of Comparative Example 4 decreased very gradually, and there was little change of the remaining percentage especially from the vicinity of 150 days, indicating that the aldehyde compound was insufficiently released after 150 days.

TABLE 2

| | Sex pheromone substance | | | Aliphatic acetate | | |
|---|---|---|---|---|---|---|
| | Aldehyde | Mass | Total | | Mass | Total |
| | compounds | ratio | carbon atoms | Compounds | ratio | carbon atoms |
| Example 4 | Z7Z11E13-16:Ald | 70 | 16 | n-18:Ac | 30 | 20 |
| Example 5 | Z7Z11E13-16:Ald | 70 | 16 | n-16:Ac | 30 | 18 |
| Comparative | Z7Z11E13-16:Ald | 100 | 16 | None | | |
| Example 4 | | | | | | |

1. A sustained-release pheromone formulation comprising at least:
a mixture containing at least a pheromone substance which is an aldehyde compound having a total of 14 to 18 carbon atoms with three or more unsaturated carbon-carbon bonds, and an aliphatic acetate having a total of 2 to 4 more carbon atoms than the total number of carbon atoms of the pheromone substance; and
a container in which the mixture is included.

2. The sustained-release pheromone formulation according to claim 1, wherein the pheromone substance is an aldehyde compound having three or more carbon-carbon double bonds and no carbon-carbon triple bond; or an aldehyde compound having two carbon-carbon double bonds and one or more carbon-carbon triple bonds.

3. The sustained-release pheromone formulation according to claim 1, wherein the pheromone substance is an aldehyde compound having three or more carbon-carbon double bonds and no carbon-carbon triple bond.

4. The sustained-release pheromone formulation according to claim 1, wherein the pheromone substance is an aldehyde compound having two carbon-carbon double bonds and one or more carbon-carbon triple bonds.

5. The sustained-release pheromone formulation according to claim 1, wherein the mass ratio of the sex pheromone to the aliphatic acetate is 95:5 to 30:70.

6. The sustained-release pheromone formulation according to claim 1, wherein the container is at least partially made of a polyolefin polymer and takes a shape of caps, tubes, capsules, ampules, bags, or bottles.

7. The sustained-release pheromone formulation according to claim 1, wherein a pest applied is a pest comprising the aldehyde compound as a pheromone substance.

8. The sustained-release pheromone formulation according to claim 1, wherein the pheromone substances are sex pheromones, alarm pheromones, trail pheromones, or aggregation pheromones, or a combination thereof.

9. The sustained-release pheromone formulation according to claim 8, wherein the pheromone substances are sex pheromones.

10. A method for controlling a pest, comprising at least a step of: installing the sustained-release pheromone formulation according to claim 1, in a field to release the pheromone substance from inside the sustained-release pheromone formulation.

11. The method according to claim 10, wherein the pheromone substances are sex pheromones, alarm pheromones, trail pheromones, or aggregation pheromones, or a combination thereof.

12. The method according to claim 11, wherein the pheromone substances are sex pheromones.
